(19) United States
(12) Patent Application Publication
(10) Pub. No.: US 2023/0072410 A1
(43) Pub. Date: Mar. 9, 2023

(54) USE OF AN ADDITIVE TO DELAY BITUMEN AGEING

(71) Applicant: Arkema France, Colombes (FR)

(72) Inventors: Rabi Inoubli, Pierre-Benite Cedex (FR); Gilles Barreto, Pierre-Benite Cedex (FR)

(73) Assignee: Arkema France, Colombes (FR)

(21) Appl. No.: 17/799,354

(22) PCT Filed: Feb. 5, 2021
(86) PCT No.: PCT/FR2021/050214

§ 371 Date: Aug. 12, 2022

(30) Foreign Application Priority Data
Feb. 14, 2020 (FR) 2001493

(51) Int. Cl. C08L 95/00; C08K 5/52; C08K 5/41

(52) U.S. Cl. CPC C08L 95/005; C08K 5/52; C08K 5/41; C08L 2555/54; C08L 2555/20

(57) ABSTRACT

The invention relates to the use of an additive chosen from the compounds of formula (1) and the compounds of formula (2) as follows: in which A, B, E, Y, Z and d and j are as defined in the description, the anti-ageing additive being present in an amount of between 0.01% and 10% by weight, relative to the total weight of the bituminous product, in order to delay the ageing of the bitumen. The invention also relates to a composition comprising:—a bituminous product,—at least one anti-ageing additive as described above, and—at least one anti-oxidant agent, the anti-ageing additive being present in an amount of between 0.01% and 10% by weight, relative to the total weight of the bituminous product.

### CROSS-REFERENCE TO RELATED APPLICATIONS

This application is a 371 filing of International Application No. PCT/FR2021/050214, filed Feb. 5, 2021, which claims priority to French Application No. 2001493, filed Feb. 14, 2020, the disclosures of these applications being incorporated herein by reference in their entireties for all purposes.

### FIELD OF THE INVENTION

The present invention relates to the use of an additive to delay bitumen aging. The invention also relates to a composition conferring on the mix, to which it is added, improved effects in terms of aging.

### BACKGROUND OF THE INVENTION

Bitumen (or asphalt) is the heaviest portion recovered during the petroleum distillation process. Due to the diverse origins and processes for distillation of such oils, the resulting bitumen can exhibit a varied range of properties and characteristics.

In the present invention, the term “bitumen” denotes not only the product obtained from petroleum by direct distillation or by reduced-pressure distillation of petroleum, but also the products obtained by extraction of pitch and oil sands, the products of oxidation and/or fluxing of such bituminous materials with carbon-based solvents, including paraffins and waxes, and also with solvents derived from plant oils, and also foamed and semi-foamed bitumens, synthetic bitumens using renewable materials such as those described in applications FR2853647 A and FR2915204 A, pitches, petroleum resins or indene-coumarone resins mixed with aromatic and/or paraffinic hydrocarbons, mixtures thereof and mixtures of such bituminous materials with acids.

The main application of bitumen is the inclusion in mixes, where the bitumen is mixed with mineral aggregates, which can be of various sizes, shapes and chemical natures, said bitumen fulfilling the function of binder in said mineral aggregates.

These mixes are particularly used in the construction, repair and maintenance of sidewalks, roads, highways, car parks or runways and airport service roads, and any other driveable surface and they are also used for sealing various substrates.

In the aforementioned fields, it is constantly sought to improve the bituminous products used. These improvements relate to production processes, whether to facilitate the logistics of transporting products on site, to reduce the impact on human beings and the environment of fumes from mixes during use, or even to reduce the durations of the processes, thus allowing the road to be put into circulation faster.

The invention relates, for its part, to the increase in the longevity of bitumen and of the products derived therefrom. Indeed, roads typically have a lifespan which varies from a few years to about twenty years. This lifespan depends on the density of traffic and bad weather. Indeed, depending on the region, some roads can experience extreme temperatures, namely temperatures that can go down to −15° C. in winter and up to 50° C. in summer. Bad weather also comprises flooding. Thus, the roads must thus be able to retain their properties in submerged conditions or in very dry conditions. The aging of roads leads to the appearance of cracks, which can be dangerous for drivers. , Likewise, in the field of sealing, bitumen aging linked to thermal variations leads to a loss of mechanical performance which results in sealing defects.

In recent years, research has been carried out to extend the lifespan of bitumens. For example, document WO2017027096 discloses the use of sterols in bitumens to improve their rheological properties.

One of the possible causes of the aging of bituminous coatings is thought to be due to an increase in the content of asphaltene. These asphaltenes are thought to be partly responsible for the hardening of the bitumen and its degraded properties.

The inventors have discovered that a certain class of additives has an effect on bitumen aging. The mechanical properties of bitumen degrade more slowly, thus extending its lifespan. In addition, in many processes for recycling bituminous materials, a heat source is used to return the degraded bituminous material to the appropriate form, thereby leading to additional degradation which is compensated for by the addition of non-recycled bituminous materials. The inventors have discovered that this same class of additives slows down the degradation in the recycling phase, thus allowing a greater inclusion of recycled bituminous materials and/or an extension of the lifespan of the new material containing them.

### SUMMARY OF THE INVENTION

A subject of the present invention is the use of at least one additive of formula (1) or (2), defined below, present in a content of between 0.01% and 10% by weight, relative to the total weight of the bitumen, to delay bitumen aging.

The invention also relates to a composition comprising a bituminous product, said anti-aging additive, and at least one antioxidant agent, to the process for preparing same and to the use thereof.

It is specified that the expressions “from . . . to . . . ” and “between . . . and . . . ” used in the present description should be understood as including each of the limits mentioned.

The anti-aging additive according to the invention is an additive chosen from the compounds of formula (1) and the compounds of formula (2) below:

[A-O-B-]_{d}Z (1)

(E)ⱼ-Y (2)

wherein:
A is chosen from a hydrogen atom, a group G, a group

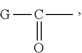

a group

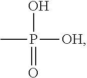

and a group

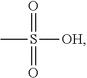

where G represents a linear or branched, saturated or unsaturated C₁-C₃₀ hydrocarbon-based chain optionally comprising at least one aromatic ring, and optionally substituted with at least one phosphate group, preferentially a single phosphate group,
B represents a divalent group containing at least one repeating unit of alkylene oxide type,
d is equal to 1 or to 2, and
Z is chosen from a hydrogen atom, a radical of formula Z1 and a radical of formula Z2:

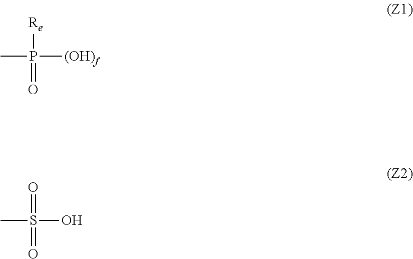

where R represents a hydrogen atom or a linear or branched C₁-C₆ alkyl group, f is equal to 0, 1 or 2, e is equal to 0 or to 1, and d+e+f is equal to 3, a group G, and a group

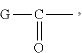

where G is as defined above,
it being understood that when d is equal to 1, then Z is chosen from a hydrogen atom, a radical of formula Z1, a radical of formula Z2, a group G, and a group

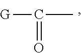

where G is as defined above,
and that when d is equal to 2, then Z represents Z1, e is equal to zero (0) and P is linked to two groups [A-O-B-] which may be identical or different, preferentially identical, as defined above,
E is chosen from the groups G,

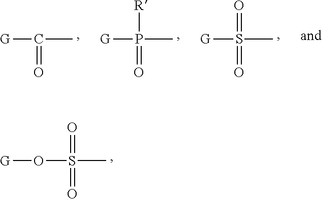

where G is as defined above,
j is equal to 1 or to 2,
R′ is chosen from the group consisting of HO-, Q-O- and Q, where Q represents a linear or branched C₁-C₆ alkyl radical,
Y represents a group chosen from -O-T, -S-T, —N(H)₍₂₋ⱼ₎-T and -NT₁T_{2,} and preferentially Y represents —N(H)₍₂₋ⱼ₎-T or -NT₁T₂, provided that Y does not represent -S-T, when E is linked to Y via a sulfur atom,
T represents a hydrogen atom or a group which is linear, branched or cyclic or contains a cyclic group and which comprises carbon and hydrogen atoms, and optionally one or more heteroatoms chosen from nitrogen, oxygen, sulfur and phosphorus, and
the radicals T₁ and T₂ are identical or different and have the same value as T defined above, or form together and with the nitrogen atom to which they are linked a saturated, partially saturated or unsaturated heterocycle optionally also comprising one or more heteroatoms chosen from nitrogen, oxygen, sulfur and phosphorus.

### DETAILED DESCRIPTION OF THE INVENTION

In the context of the present invention, the term “alkylene oxide” preferentially means butylene oxide (BO), propylene oxide (PO) or ethylene oxide (EO), it being understood that a “divalent group containing at least one repeating unit of alkylene oxide type” is a divalent group which may include one or more BO and/or PO and/or EO repeating units.

More preferentially, B represents a divalent group comprising repeating units of propylene oxide (PO) and/or ethylene oxide (EO) type, generally distributed randomly or in blocks, preferentially in blocks. Even more preferentially, B represents a block or random copolymer of ethylene oxide and propylene oxide comprising between 4 and 500 repeating units, with a mass ratio (ethylene oxide/copolymer) of between 1% and 70%.

Preferably, A denotes a hydrogen atom, B denotes a divalent group comprising repeating units of butylene oxide (BO), propylene oxide (PO) and/or ethylene oxide (EO) type, generally distributed randomly or in blocks, preferentially in blocks, d is equal to 1 and Z denotes a hydrogen atom.

Even more preferentially, A denotes a hydrogen atom, B represents a block, alternating or random copolymer comprising one or more ethylene oxide units and/or one or more propylene oxide units, and/or one or more butylene oxide units, and comprising a total of between 4 and 500 repeating units, d is equal to 1 and Z denotes a hydrogen atom.

Even more preferentially, A denotes a hydrogen atom, B represents a block, alternating or random copolymer comprising one or more ethylene oxide units and one or more propylene oxide units, and comprising a total of between 4 and 500 repeating units, d is equal to 1 and Z denotes a hydrogen atom.

These products are sold by Arkema France under the trade name Ensoline®.

Preferentially, Z represents Z1, B includes and preferentially represents —(CH₂CH(CH₃)O)_{g}—(CH₂CH₂O)ₕ- distributed randomly or in blocks, where g is between 0 and 10 and h is between 0 and 80, the sum g+h not being equal to 0, preferentially between 1 and 60, and more preferentially between 2 and 40. In this case, the additive of formula (1) can be represented by formula A1ₒ:

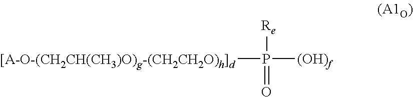

wherein A, R, d, e, f, g and h are as described above.

Alternatively, when the PO and/or EO repeating units (distributed randomly or in blocks) are linked to Z by a hydrocarbon-based chain, and when Z represents Z1, the additive of formula (1) can be described by formula A1_{C} below:

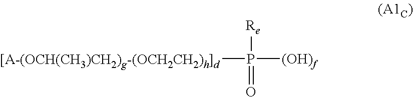

wherein A, R, d, e, f, g and h are as described above.

In one preferred embodiment, in the additive of general formula (1), g represents 0, when A comprises at least 10 carbon atoms. Still in a preferred embodiment, in the additive of general formula (1), g is preferably between 1 and 80, preferentially between 2 and 60, when A contains less than 10 carbon atoms.

According to yet another embodiment of the present invention, the groups A and Z represent a hydrogen atom and B represents a block or random copolymer of ethylene oxide and propylene oxide comprising between 4 and 500 repeating units, with a mass ratio (ethylene oxide/copolymer) of between 1% and 70%. Preferentially, B represents a triblock copolymer, the propylene oxide constituting the middle block. In this case, the additive of formula (1) can be represented by formula (A1_{H}) below:

H—O—(CH₂CH₂—O)ₓ—(CH₂-CH(CH₃)O)_{y}—(CH₂CH₂—O)_{z}—H (A1_{H})

wherein x, y and z represent the number of repeating units of each type, the sum x+y+z being between 4 and 500, and the ratio 44(x+z)/(44(x+z)+57y) being between 0.1 and 0.7.

According to yet another aspect of the present invention, the group A represents a hydrogen atom, d is equal to 1, Z represents a group G or a group

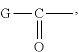

where G represents a linear or branched, saturated or unsaturated C₁-C₃₀ hydrocarbon-based chain, optionally comprising at least one aromatic ring, and B represents a divalent group comprising at least one propylene oxide (PO) repeating unit and/or at least one ethylene oxide (EO) repeating unit.

According to yet another aspect of the present invention, the additive corresponds to formula (1) defined above, wherein d is equal to 1, Z represents Z1, B is as defined above, and A represents a group

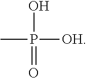

According to another aspect of the present invention, the additive corresponds to formula (1), wherein d is equal to 2, in which case said formula (1) can be represented by formula (A1₂):

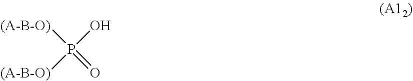

wherein the two groups (A-O-B-) are identical or different, preferentially identical, the groups A and B being as defined above.

In another preferred embodiment, the additive of formula (1) does not contain more than 3 phosphorus atoms.

All the additives of formula (1) as defined above, including the additives of formulae A1ₒ, A1_{C}, A1_{H} and A1₂, are known compounds and can be easily obtained from known suppliers, or, alternatively, can be easily synthesized according to procedures available in patents, in the non-patent literature, in scientific publications, or in Chemical Abstracts.

Examples of additives of formula (1) for use in the context of the present invention can be phosphoric acid esters, such as for example those sold by Lakeland Chemical under the generic name Lakeland.

In one preferred embodiment, the groups T or T₁ and T₂ represent a group containing a polyalkylamine or a group containing an imidazolidone, imidazolidinone or imidazoline group. Even more preferentially, the group containing a polyalkylamine is a group derived from one of the following groups: dimethylaminopropylamine, N-aminoethylpiperazine, diethylenetriamine, triethylenetetramine, tetraethylenepentamine, pentaethylenehexamine (PEHA), and higher homologs, such as for example higher homologs known under the generic name of “Higher Ethylene PolyAmine” in English, better known under the acronym HEPA, and others.

In another preferred embodiment, the groups T or T₁ and T₂ represent a group containing a group containing an imidazolidone group derived from one of the following groups: 1-(2-aminoethyl)imidazolidin-2-one (UDETA), 1-(2-[(2-aminoethyl)amino]ethyl)imidazolidone (UTETA), 1-(2-{2-[(2- aminoethylamino]ethyl}amino)ethyl]imidazolidone (UTEPA), 11-mercapto-N-(2-(2-oxoimidazolidin-l-yl)ethyl)undecanamide, 1-(2-hydroxyethyl)imidazolidin-2-one (HEIO), N-(6-aminohexyl)-N′-(6-methyl-4-oxo-1,4-dihydropyrimidin-2-yl)urea (UPy), 3-amino-1,2,4-triazole (3-ATA), 4-amino-1,2,4-triazole (4-ATA), etc. Most preferentially, T is derived from UDETA and is a preferred derivative representing T.

According to another preferred embodiment of the invention, the additive is of formula (2), wherein the group E represents a group G or a group

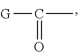

and preferably E represents a group G, where G represents a linear or branched, preferentially linear, saturated or partially unsaturated, preferably partially unsaturated, C₁₄-C₂₂ hydrocarbon-based chain, j is equal to 1 and Y is a polyethyleneamine. In this case, the additive of formula (2) can be represented by formula E1_{A}:

G-NH—((CH₂—)ₘ—NH)ₖ—H (E1_{A}),

wherein m ranges from 2 to 6 and k ranges from 1 to 20, preferably 1 to 15, more preferably from 1 to 10, even better from 1 to 5, preferably m is 2, 3 or 4, more particularly m is 2 or 3.

In another preferred embodiment, the additive is represented by formula (2), wherein E represents a group

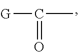

where G represents a linear or branched, preferentially linear, saturated or partially unsaturated, preferably partially unsaturated, C₁₄-C₂₂ hydrocarbon-based chain, j is equal to 1 and Y represents a polyethyleneamine. In this case, the additive of formula (2) can be represented by formula E1_{B}:

G-CO—NH—((CH₂—)ₘ—NH)ₖ—H (E1_{B}),

wherein G, m and k are as defined above.

Examples of additives of formula E1_{B} for use in the context of the present invention can be easily obtained from Arkema France under the generic brand Cecabase®.

Examples of additives of formula (E1_{A}) and of formula (E1_{B}) for the use according to the present invention are available for example from Arkema France in the Polyram® range.

In another additional preferred embodiment, the additive is represented by formula (2), wherein E represents a group

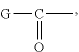

where G represents a linear, saturated or partially unsaturated, preferentially partially unsaturated, C₁₄-C₂₂ hydrocarbon-based chain, j is equal to 1 and Y represents a radical derived from the following: 1-(2-aminoethyl)imidazolidin-2-one (UDETA), 1-(2-hydroxyethyl)imidazolidin-2-one (HEIO) or 1-(2-mercaptoethyl)imidazolidin-2-one. In these cases, the additives of formula (2) can be respectively represented by formulae E1_{C}, E1_{D} and E1_{E}:

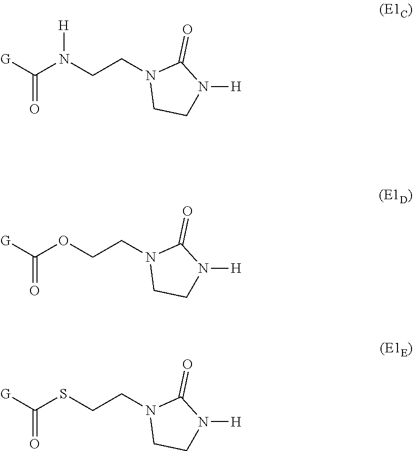

Some of the additives defined above of formula (2), including those of formula E1_{A}, E1_{B}, E1_{C}, E1_{D}, E1_{E}, are known compounds, and are for example described in application WO2006016041, or else can be easily obtained from known suppliers, or, alternatively, are easily synthesized by following known procedures, available in patents or the non-patent literature, in scientific publications, or in Chemical Abstracts.

In another embodiment of the present invention, the additives of formula (2) defined above can be modified by following general methods known to those skilled in the art, such as, for example and in a nonlimiting way, by reaction with alkylene oxides, for example EO (ethylene oxides) and/or PO (propylene oxides) and/or BO (butylene oxides); or by ionization with an inorganic or organic acid, such as hydrochloric acid, phosphoric acid or acetic acid.

Examples of additives modified by reaction with alkylene oxides for use in the context of the present invention are commercially available and can for example be easily obtained from Arkema France under the generic brands Noramox® and Dinoramox®.

The bitumens used in the present invention are bitumens from various origins. Mention may first of all be made of bitumens of natural origin, those contained in natural bitumen deposits, natural asphalt deposits, or tar sands.

The bitumens according to the invention are also bitumens originating from the refining of crude oil. The bitumens originate from the atmospheric and/or vacuum distillation of petroleum. These bitumens can optionally be oxidized, blown, visbroken and/or deasphalted.

The bitumens may be hard-grade or soft-grade bitumens. The various bitumens obtained by means of refining processes may be combined together to obtain the best technical compromise.

The bitumens used may also be bitumens fluxed by addition of volatile solvents, of fluxing agents of petroleum origin, of carbochemical fluxing agents and/or of fluxing agents of plant origin.

Polymer-modified bitumens may also be used. As polymer, mention may, for example and by way of nonlimiting indication, be made of thermoplastic elastomers such as linear or star-branched styrene/butadiene (SBR, SBS) or styrene/isoprene (SIS) random or block copolymers, which are optionally crosslinked, ethylene/vinyl acetate copolymers, olefinic homopolymers and copolymers of ethylene (or propylene or butylene), polyisobutylenes, polybutadienes, polyisoprenes, poly(vinyl chloride), reground rubbers or else any polymer used to modify bitumens, and blends thereof. An amount of polymer of from 2 to 10% by weight relative to the weight of bitumen is generally used.

Synthetic bitumens, also known as clear, pigmentable or colorable bitumens, may also be used. These bitumens contain little or no asphaltenes and can consequently be colored. These synthetic bitumens are based on petroleum resin and/or on indene-coumarone resin and on lubricating oil, as described for example in patent EP179510.

Advantageously, the bitumen is a bitumen with a penetrability, measured according to the standard NF EN 1426 of June 2007, ranging from 10 to 300, preferentially from 20 to 220, more preferentially from 70 to 220.

Preferably, the bitumen according to the invention is chosen from unmodified bitumens from the refining of crude oil.

Preferably, the bitumen used according to the invention is fresh bitumen. For the purposes of the present invention, the term “fresh” bitumen means a bitumen which has not yet been brought into contact with aggregates or which has not yet been spread. A fresh bitumen is referred to as “neat”.

The bitumen used according to the invention can also be a recycled bituminous product. In this eventuality, the mineral aggregates used in the mixes are generally quarry products, and are increasingly often used in combination with aggregates recycled from previously manufactured mixes. Such recycled aggregates are known under the generic name of mix millings or mix aggregates or RAP (Reclaimed Asphalt Pavement), for example defined in the French standard AFNOR XP P98-135 of December 2001 or in the Asphalt Handbook, MS-4, 7^{th} edition, published by the Asphalt Institute, USA.

RAPs also include recycled mixes where the mineral aggregates are partially or totally replaced by other common components, such as, by way of limiting examples, organic and inorganic fibers (for example glass, metal or carbon fibers, cellulose, cotton, etc.), polymers (for example polypropylenes, polyesters, poly(vinyl alcohols), polyamides, polyurethanes, polyureas), copolymers of ethylene and vinyl acetate (EVA) and styrene-butadiene-styrene (SBS).

Recovered or recycled aggregates, commonly called “mix millings” or RAPs, are of particular interest. These aggregates result from the milling, or any other method of crushing, of previous mixes, generally damaged and requiring replacement. These recycled aggregates contain bitumen used as a binder during the initial manufacture.

Other sources of bituminous products that can also be recycled in the manufacture of mixes include, for example, roofing products (e.g. shingles or waterproofing membranes, and also waste from their production), thermal insulation materials or soundproofing materials. These bituminous products generally do not contain mineral fillers.

In the description of the present invention, the term “bituminous product” means bitumens, and also the mixture thereof with organic or mineral fillers, preferably mineral fillers, such as sand, gravel, pebbles, aggregates.

The term “recycled bituminous product” means any manufactured product comprising bitumen as one of its components, said manufactured product comprising bitumen having been previously used or discarded after production. Nonlimiting examples of such recycled bituminous products include mix millings or RAPs obtained by milling roads or other driveable surfaces, waterproofing membranes, bituminous shingles used for roofing (shingle millings or RAS for reclaimed asphalt shingle), soundproofing panels, production waste, mixtures of two or more of the above elements.

According to a first embodiment, the bitumen into which the additive according to the invention is introduced does not contain recycled bitumen.

According to a second embodiment of the invention, the bitumen into which the additive according to the invention is introduced is a mixture of non-recycled bitumen and recycled bitumen, such as RAP. Preferably, the bitumen comprises from 10% to 90% by weight of recycled bitumen, and more preferentially from 20% to 80% by weight, particularly from 30% to 70% by weight, and even more preferably from 40% to 60% by weight relative to the total weight of the mixture.

According to a third embodiment of the invention, the bitumen into which the additive according to the invention is introduced comprises only recycled bitumen.

The additive according to the invention must be present in the bitumen in a content of between 0.01% and 10% by weight, preferably between 0.05% and 10% by weight, more particularly between 0.05% and 8% by weight, and even more preferentially between 0.05% and 5% by weight relative to the total weight of the bituminous product.

The additive can be added to the bitumen in pure form or else in diluted form, that is to say dissolved, dispersed or emulsified in a liquid. The liquids suitable for dissolving, dispersing or emulsifying the anti-aging additive can be water, organic or inorganic solvents, such as alcohols or plant or mineral oils. Preferably, organic solvents are preferred.

As for the bitumen, it can be in anhydrous form, in the form of an emulsion or else in the form of a foam.

The aging of the bitumen obtained by adding the additive according to the invention is evaluated by measuring an aging index, denoted I according to the formula below:

$$I = \frac{G * / sin ( δ ) ( aged )}{G * / sin ( δ ) ( unaged )}$$

wherein
G*/sin(δ) is measured using an AntonPaar MCR 301 rheometer with imposed stress, called a DSR, and a plate/plate geometry device with a diameter of 25 mm and a gap of 1 mm; the measurements are taken by scanning of the temperature from 80 to 40° C. at a frequency of 0.1 Hz and under a deformation of 1%. The reference temperature is 45° C.

This index is defined in the following scientific article: Alex K. Apeagyei; Laboratory evaluation of antioxidants for asphalt binders; Construction and Building Materials 25; (2011); 47-53.

This aging index is a ratio between the values of G*/sin(δ) of the thermally aged system and the unaged system. The higher this ratio, the more the system has undergone aging, which has resulted in an increase in its modulus.

It has been observed that using the additive allows a significant slowing-down of the aging of the bitumen to which the additive has thus been added.

The anti-aging additive according to the invention can be added to the bitumen at any time in the supply chain from the refinery to the site where the bituminous product and the aggregates are mixed. During additivation, the temperature of the bituminous product is generally between 100 and 250° C., depending on the penetrability class of the bituminous product and its ring and ball softening point, and the temperature of the additive is generally between ambient temperature and 200° C., taking into account, for obvious safety reasons, the flash point of the additive used. In the case where the additive is kept hot, it can advantageously be kept stirred to avoid hot and cold spots. The additive can be added in the solid state, either by a manual mechanical operation, or by the use of a metering system suitable for solid products. The additive can also be added in the liquid state, either by pouring into a tank containing the bituminous product, in which case recirculation over a period generally of at least 15 minutes minimum is necessary before use, or by addition to a pipe transporting the bituminous product. The piping transporting the bituminous product downstream of the injection point can be equipped with a static mixer to facilitate the dispersion of the additive. In the case of the addition of the additive according to the invention into a tank containing the bituminous product, the bituminous product with additive can be stored in the same way as the bituminous product without additive, without presenting any additional disadvantage at this stage of the process.

Preferably, the anti-aging additive according to the invention is introduced into a bituminous composition according to the following process:
a) heating the “neat” bitumen to a temperature of between 100 and 200° C.,
b) adding the anti-aging agent to the heated bitumen,
c) the mixture is stirred, preferably vigorously, then the mixture is optionally emulsified using an aqueous solution of cationic or anionic or nonionic or amphoteric or zwitterionic surfactants, to produce a bitumen emulsion, and
d) the mixture or the emulsion is optionally left to cool.

The bituminous product with additive according to the invention can then be mixed with aggregates, the latter being maintained at a temperature of between 5° C. and 200° C., either by storage without energy input, or by heating, but preferentially between 10° C. and 200° C. and even more preferentially between 100 and 200° C. During mixing, the temperature of the bituminous product is between 5° C. and 250° C., and preferentially between 20° C. and 250° C., and more preferentially between 100 and 250° C. These temperatures depend firstly on the penetrability class of the bituminous product: the lower this is, the hotter the bituminous product and the aggregate must be. These temperatures also depend on the ring and ball softening point of the bituminous product: the higher this is, the hotter the bituminous product and the aggregate must be.

A subject of the invention is also a composition comprising:
a bituminous product,
at least one anti-aging additive as defined above, and
at least one antioxidant,
   the anti-aging additive being present in a content of between 0.01% and 10% by weight, relative to the total weight of the bituminous product.

The composition preferably comprises the anti-aging additive in a content of between 0.01% and 10% by weight, preferably between 0.05% and 10% by weight, more particularly between 0.05% and 8% by weight, and even more preferentially between 0.05% and 5% by weight relative to the total weight of the bitumen product.

The anti-aging additive and the bituminous product are as defined above.

It is possible for the composition not to comprise any solvent. However, according to another embodiment, the composition according to the invention may be in a form diluted in a solvent. Thus, the composition can comprise water, organic solvents, inorganic solvents and mixtures thereof. The organic solvents can be chosen from alcohols, plant oils and mineral oils. Preferably, organic solvents are preferred. Depending on the solvent present in the composition, the latter may be in the form of an emulsion.

Preferably, the composition is in the form of an emulsion, comprising water and one or more emulsifiers, optionally one or more organic or mineral acids or organic or mineral bases.

The emulsifiers can be cationic or anionic or nonionic or amphoteric or zwitterionic surfactants.

The antioxidant is defined in the Asphalt handbook (MS-4, 7^{th} edition, 2017). The antioxidant can be a primary antioxidant, also called a radical scavenger; a secondary antioxidant, also called a preventive antioxidant or “hydroperoxide decomposer”; a UV absorber or else a metal deactivator, and mixtures thereof.

Preferably, the antioxidant is chosen from compounds of phenolic structure, phosphite derivatives, hindered amine derivatives and anti-UV compounds.

As a phenolic primary antioxidant, compounds with the trade name Irganox 245® or Irganox 1098® or Irganox 1010® from Ciba can be used. As a hindered amine derivative secondary antioxidant, Tinuvin 770® from Ciba can be used. Naugard 445® from Crompton is an amine-derived antioxidant. Tinuvin 312® from Ciba can be used as an antioxidant against UV rays.

The antioxidant may be present within the composition in a content preferentially of between 0.01% and 10% by weight of antioxidant relative to the total weight of the composition, preferably between 0.05% and 5% by weight and more particularly between 0.05% and 2.5% by weight relative to the total weight of the composition.

Preferably, the mass ratio of the anti-aging additive to the antioxidant is between 1/0.01 and 1/1.

The composition can be introduced into the bitumen in a content of between 0.5% and 5% by weight, relative to the total weight of the bituminous product.

The composition may also comprise one or more other additives commonly used in the field of bitumens and mixes, it being possible for such additives to be chosen from the following:
adhesiveness dopes
polyphosphoric acid, including all the different qualities and designations existing for polyphosphoric acids, which includes pyrophosphoric acid, triphosphoric and metaphosphoric acids and phosphonic acid,
pyrophosphates and other similar compounds comprising at least one (OH-)P═O group, such as those described in WO 2008/148974,
polymers generally used to improve the mechanical performance of bitumen and mixes,
waxes, such as Fischer-Tropsch waxes, for example described in U.S. Pat. No. 6,588,974,
fluxing agents,
organic or inorganic acids,
fatty acid esters and functionalized waxes,
resin-like components, such as rosin acids, or modified rosin acids, tall oil pitch, pine tar pitch, pine rosins, tall oil rosins,
asphaltites, for example Gilsonite®,
oils of plant or mineral origin and derivatives thereof,
organic fibers (for example: cellulose, cotton, polypropylene, polyester, polyvinyl alcohol and polyamide fibers) and/or inorganic fibers (for example: glass, metal or carbon fibers),
sterols as defined in document WO2017027096,
and also mixtures of two or more of the above additional additives.

Such additional additives are preferentially added to the bitumen, either neat or recycled, or to the mixture of neat and recycled bitumens.

Nonlimiting examples of polymers generally employed to improve the mechanical performance of bitumens and mixtures, i.e. commonly employed in the modification of bitumens, include the following: styrene-butadiene rubbers, styrene/butadiene block copolymers, ethylene/vinyl acetate copolymers, polyethylene and other alpha-polyolefins, such as for example those described in the Asphalt binder testing manual, Asphalt Institute (2007).

The composition according to the invention can be prepared by mixing the anti-aging additive and the antioxidant. Then, the mixture is added to the bituminous product while hot, that is to say between 100 and 250° C. The additives can be added to the bitumen simultaneously, or sequentially in any order.

The invention also relates to the use of the composition as defined above for delaying the aging of bitumens used as road coverings, sidewalks, aircraft runways, cycle paths, parking areas, and also for sealing.

A subject of the invention is also a mix comprising the composition as defined above and mineral aggregates.

Finally, the invention relates to a drivable surface made from the mix defined above. The drivable surface can be road coverings, sidewalks, aircraft runways, cycle paths, parking areas.

Examples of applications of the present invention include the production of mixes containing mineral aggregates, said mixes being used for earthworks and sealing, and more specifically in the construction, repair and maintenance of sidewalks, roads, highways, parking lots or airport runways and service roads, and any other driveable surface.

The invention is illustrated by the following examples, which are in no way limiting.

### EXAMPLES

### Sample Preparation

Samples are prepared from the bituminous compositions shown in table 1 below. The contents are expressed as weight percentages:

TABLE 1

| | | 2 | 3 |
|---|---|---|---|
| | 1 | (according to | (according to |
| Example | (comparative) | the invention) | the invention) |
| Bitumen | 100 | 99.4 | 99.4 |
| Additive 1 | — | 0.6 | — |
| (Ensoline ® | | | |
| PGE3600) | | | |
| Additive 2 | — | — | 0.6 |
| (Polyram ® L920) | | | |

The bitumen used is the 160/200 bitumen sold by Total and originating from the Feyzin plant. Additive 1 is an Ensoline PEG 3600 copolymer® sold by Arkema France. Additive 2 is a Polyram® L920 amidoamine-type additive sold by Arkema France.

The bitumen and the additive are mixed as follows: 50 g of bitumen (ambient temperature) are heated for 30 min at 150° C. The additive is then added, and the mixture is stirred for 3 minutes at 400 rpm with a Raneyri mixer. Then, this mixture is allowed to cool to ambient temperature.

A thin layer film of 200 μm is produced on a metal plate. Two samples are made for each bituminous composition. The first series of samples will be used to measure unaged G*/sin(δ). The second series of samples will be aged, then the aged G*/sin(δ) will be measured.

The first series of measurements is carried out on the prepared samples. The thin layer film is placed on the lower plate of the plate/plate equipment of the rheometer. After adjustment of the gap, the rheology measurements are carried out. This first measurement carried out on the film, before aging, is noted as “unaged”.

A second series of samples is placed for thermal aging in a ventilated oven at a temperature of 150° C. for 2 hours.

After aging, the films are left at ambient temperature for cooling. Each sample is then placed on the lower plate of the plate/plate equipment of the rheometer. After adjustment of the gap, the rheology measurements are carried out in order to obtain the aging index I, as calculated according to the formula defined in the paragraph above. The results obtained are collated in table 2.

TABLE 2

| | Example 1 | Example 2 | Example 3 |
|---|---|---|---|
| Aging index (I) | 5 | 4 | 3.6 |

The results show that the presence of the additive in the bitumen makes it possible to slow down the bitumen aging. Depending on the values obtained, a slowing down of aging of 20% to 28% is observed.

1. A composition comprising:
a bituminous product;
at least one anti-aging additive; and
at least one antioxidant,
wherein the at least one anti-aging additive is chosen from the compounds of formula (1) and the compounds of formula (2):
[A-O-B-]_{d}Z (1)
(E)ⱼ-Y (2)
wherein:
A is chosen from a hydrogen atom, a group G, a group 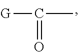
a group 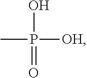
and a group 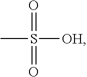
where G represents a linear or branched, saturated or unsaturated C₁-C₃₀ hydrocarbon-based chain optionally comprising at least one aromatic ring, and optionally substituted with at least one phosphate group,
B represents a divalent group containing at least one repeating unit of alkylene oxide type,
d is equal to 1 or 2, and
Z is chosen from a hydrogen atom, a radical of formula Z1 and a radical of formula Z2: 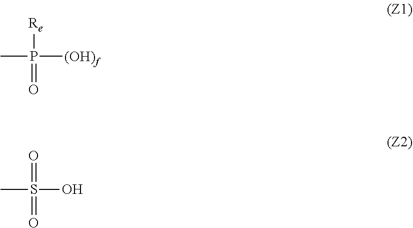
where R represents a hydrogen atom or a linear or branched C₁-C₆ alkyl group, f is equal to 0, 1 or 2, e is equal to 0 or to 1, and d+e+f is equal to 3, a group G, and a group 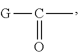
where G is as defined above, with the provio that when d is equal to 1, then Z is chosen from a hydrogen atom, a radical of formula Z1, a radical of formula Z2, a group G, and a group 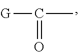
where G is as defined above, and that when d is equal to 2, then Z represents Z1, e is equal to zero (0) and P is linked to two groups [A-O-B-] which may be identical or different, as defined above,
E is chosen from the groups G, 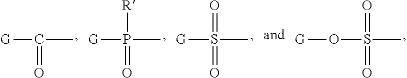
where G is as defined above,
j is equal to 1 or to 2,
R′ is chosen from the group consisting of HO—, Q-O— and Q, where Q represents a linear or branched C₁-C₆ alkyl radical,
Y represents a group chosen from -O-T, -S-T, -N(H)(₂₋ⱼ)-T and -NT₁T₂, provided that Y does not represent -S-T, when E is linked to Y via a sulfur atom,
T represents a hydrogen atom or a group which is linear, branched or cyclic or contains a cyclic group and which comprises carbon and hydrogen atoms, and optionally one or more heteroatoms chosen from nitrogen, oxygen, sulfur and phosphorus, and
the radicals T₁ and T₂ are identical or different and have the same value as T defined above, or form together and with the nitrogen atom to which they are linked a saturated, partially saturated or unsaturated heterocycle optionally also comprising one or more heteroatoms chosen from nitrogen, oxygen, sulfur and phosphorus, and
wherein the additive is present in a content of between 0.01% and 10% by weight, relative to the total weight of the bituminous product.

2. The composition as claimed in claim 1, wherein the additive is of formula (1) and comprises a group A denoting a hydrogen atom, B denoting a divalent group comprising repeating units of butylene oxide (BO), propylene oxide (PO) and/or ethylene oxide (EO) type, d being equal to 1 and Z denoting a hydrogen atom.

3. The composition as claimed in claim 2, wherein the additive is of formula (1) and comprises a group A denoting a hydrogen atom, B representing a block or random copolymer of ethylene oxide and propylene oxide comprising between 4 and 500 repeating units, d being equal to 1 and Z denoting a hydrogen atom.

4. The composition as claimed in claim 1, wherein the additive is of formula (2), wherein the group E represents a group G or a group 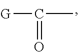
where G represents a linear or branched, saturated or partially unsaturated, C₁₄-C₂₂ hydrocarbon-based chain, j is equal to 1 and Y is a polyethyleneamine.

5. The composition as claimed in claim 1, wherein the additive is present in the bitumen in a content of between 0.05% and 10% by weight, relative to the total weight of the bituminous product.

6. The composition as claimed in claim 1, wherein the additive is added to neat bitumen.

7. The composition as claimed in claim 1, wherein the additive is added to a mixture of neat bitumen and recycled bitumen.

8. The composition as claimed in claim 1, wherein the additive is added to a recycled bitumen.

9. (canceled)

10. The composition as claimed in claim 1, wherein the composition is in the form of an emulsion.

11. The composition as claimed in claim 1, wherein the composition comprises an antioxidant chosen from a primary antioxidant, a secondary antioxidant, a UV absorber, a metal deactivator, and mixtures thereof.

12. The composition as claimed in claim 1, wherein the mass ratio of the anti-aging additive to the antioxidant is between 1/0.01 and 1/1.

13. A method for delaying aging of bitumens, comprising added to a composition containing the bitumens the composition according to claim 1.

14. A mix comprising the composition according to claim 1 and mineral aggregates.

15. The method according to claim 13, wherein the composition containing the bitumens is used as road coverings, sidewalks, aircraft runways, cycle paths, parking areas, and also for sealing.
